(19) United States
(12) Patent Application Publication
(10) Pub. No.: US 2004/0210464 A1
(43) Pub. Date: Oct. 21, 2004

(54) System, method and computer product for implementing engineered labour standards

(76) Inventors: Joseph Joey Yves Belanger, Mississauga (CA); Darren Allen Elliott, Toronto (CA); Victor Farouk Zaki Barsoum, Woodbridge (CA); Joseph Harry Henri Georges Bishop, Caldeon (CA); Mark Philip Armer, Maple (CA)

Correspondence Address: MILLER THOMPSON, LLP, 20 QUEEN STREET WEST, SUITE 2500, TORONTO, ON, M5H 3S1, CA

(21) Appl. No.: 10/317,128

(22) Filed: Dec. 12, 2002

(51) Int. Cl. G06F 17/60

(52) U.S. Cl. 705/7

(57) ABSTRACT

A system, computer product and method is provided for establishing labour standards at a workplace. The system and computer product includes a travel calculation facility that facilitates the calculation of the time required to travel along a specified path at the workplace. The system and computer product also includes a task calculation facility that permits a user to build formulae for calculating the time required to complete a task using a formula element repository. The system and computer product enable the combination of the time required to complete a task with the time required to travel the path involved in completing the task to define the time that it should take in total to complete a task including travel time. The method of the invention involves the use of the travel calculation facility and task calculation facility to define the labour standards for the workplace. A further aspect of the invention is an audit facility that enables the processes of the travel calculation facility to be audited to validate the integrity of the defined labour standards.

### FIELD OF INVENTION

This invention relates in general to systems, computer products and methods for optimizing the performance of workers. This invention relates more particularly to a system, computer product and method for establishing worker performance standards, and comparing worker performance to such standards.

### BACKGROUND OF INVENTION

Engineered labour standards are known. Engineered labour standards relate generally to the establishment of worker output performance criteria based on the calculation of the optimal time for completing a particular assignment.

The calculation of optimal times for completing assignments, including travel time is well known. However, the deployment of engineered labour standards at a work site such as a warehouse poses a number of challenges including the following. Deployment of engineered labour standards generally requires engagement of skilled professionals to assess the criteria affecting worker output performance and formulation of the output performance criteria based on such criteria and formulas known in the area of industrial or process engineering. A significant amount of data relevant to engineered labour standards is present in existing Warehouse Management Systems (WMS's). Prior art technologies and methods do not generally teach a method whereby data from a WMS can be effectively used in support of the deployment of engineered labour standards. Engineered labour standards are commonly challenged by workers or their unions. While there are productivity benefits to engineered labour standards, when these are not transparent and not readily justifiable or do not adequately account for legitimate factors affecting worker productivity such as congestion, travel time, and vehicle performance, the engineered labour standards do not generally achieve their purpose of productivity improvement.

There is a need therefore for a system, computer product and method for deploying engineered labour standards that is easy to use and accounts for legitimate factors affecting worker productivity such as congestion, travel time and vehicle performance. There is a further need for a system, computer product and method whereby the labour standards established for a workplace are relatively transparent. There is a further need for a system, computer product and method whereby labour standards for a particular workplace are established and deployed efficiently.

### BRIEF DESCRIPTION OF THE DRAWINGS

A detailed description of a several embodiments is provided herein below by way of example only and with reference to the following drawings, in which:

FIG. 1a is a system resource flowchart illustrating the resources of the system of the present invention in accordance with an embodiment of the present invention whereby the system of the present invention interfaces with a WMS.

FIG. 1b is a system resource flowchart illustrating the resources of system of the present invention in accordance with an embodiment of the present invention whereby the system of present invention is part of a WMS system.

FIG. 2a is a more detailed system resource flowchart illustrating the resources of the present invention, as well as certain inputs that are provided to the system and computer product herein, in accordance with one embodiment thereof.

FIG. 2b is a further system resource flowchart that illustrates the WMS data inputs to the system of the present invention, in accordance with one embodiment thereof.

FIG. 3 is an application resource flowchart illustrating the resources of the computer application of the present invention.

FIG. 4 is a table illustrating a representative implementation of the method of the present invention.

FIG. 5a is a representation of a map of a physical site that is mapped using the travel calculation facility of the present invention.

FIG. 5b illustrates a data screen displayed by the travel calculation facility of the present invention that permits the audit of the shortest paths between travel nodes.

FIG. 6a illustrates the data interface screens used in accordance with one embodiment of the travel calculation facility in order to input the values for operation of the travel calculation facility.

FIG. 6b illustrates the field names denoting the values that are input in the travel calculation facility, in one embodiment thereof.

FIG. 7a illustrates the operation of the travel calculation facility in a representative embodiment out a data output screen thereof.

FIG. 7b further illustrates the operation of the travel calculation facility of the present invention, in one embodiment thereof, in relation to a representation of a map of a physical location in relation to which data has been provided to the travel calculation facility.

FIG. 8 is a representative illustration of a user interface for building formulae by operation of the task calculation facility of the present invention.

FIG. 9a is a representative illustration of a data input interface for inputting vehicle performance data.

FIG. 9b is a further representative illustration of a data input interface for inputting vehicle performance data.

FIG. 10 is a representative illustration of a data input interface for inputting congestion data.

In the drawings, preferred embodiments of the invention are illustrated by way of example. It is to be expressly understood that the description and drawings are only for the purpose of illustration and as an aid to understanding, and are not intended as a definition of the limits of the invention.

### SUMMARY OF THE INVENTION

It is one object of the present invention to provide a system, computer product and method for establishing and deploying labour standards at a workplace.

One aspect of the invention is a method for establishing and deploying labour standards at a workplace comprising the following steps: (a) mapping the workplace by establishing a travel node network including a plurality of travel nodes in an xyz coordinate system defining a plurality of locations at the workplace; (b) providing as a data input to a travel calculation facility the factors affecting travel between any two of said travel nodes; (c) calculating the most efficient travel path between any two such travel nodes; and (d) creating and deploying labour standards at the workplace based on said most efficient travel path.

In another aspect of the present invention, a method for establishing and deploying labour standards at a workplace is provided comprising the following steps: (a) providing a task calculation facility that includes a formula builder for building formulae for calculating the time required to complete a plurality of tasks at the workplace; (b) selecting one or more of a plurality of formula elements from an element repository; (c) combining the formula elements using the formula builder to define a series of task calculation formulae; (d) applying the task calculation formulae to data inputs to calculate the time required to complete a task; and (e) creating and deploying labour standards at the workplace based on the calculated time required to complete tasks at the workplace.

In yet another aspect of the present invention, a method for establishing and deploying labour standards at a workplace is provided comprising the steps of: (a) calculating the time required to complete a task at the workplace independent of travel time using the task calculation facility; and (b) calculating the time required to complete travel involved in the completion of the task; (c) adding the results of (a) and (b) to define the total time required to complete the task; and (d) creating and deploying labour standards at the workplace based on such total task completion time.

### DETAILED DESCRIPTION OF THE PREFERRED EMBODIMENTS

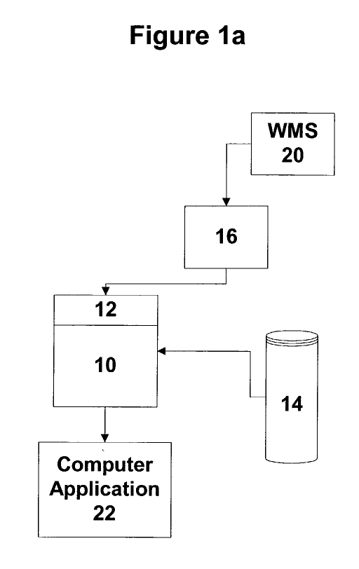

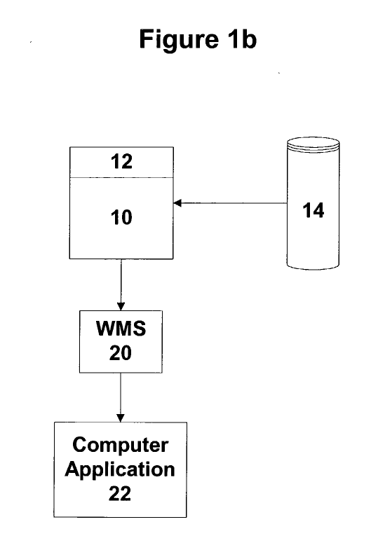

As best shown in FIG. 1, the system of the present invention includes a computer 10 that includes a microprocessor 12. The computer 10 is functionally linked to a database 14. The computer 10 may include any manner of personal computer or server computer.

FIG. 1 Illustrates an implementation of the system of the present invention whereby a data interface 16 is provided such that base data (described below) is obtained from a known Warehouse Management Systems (“WMS”) 20. The data interface 16 is designed in a manner that is known that permits interfacing with a wide variety of WMS products.

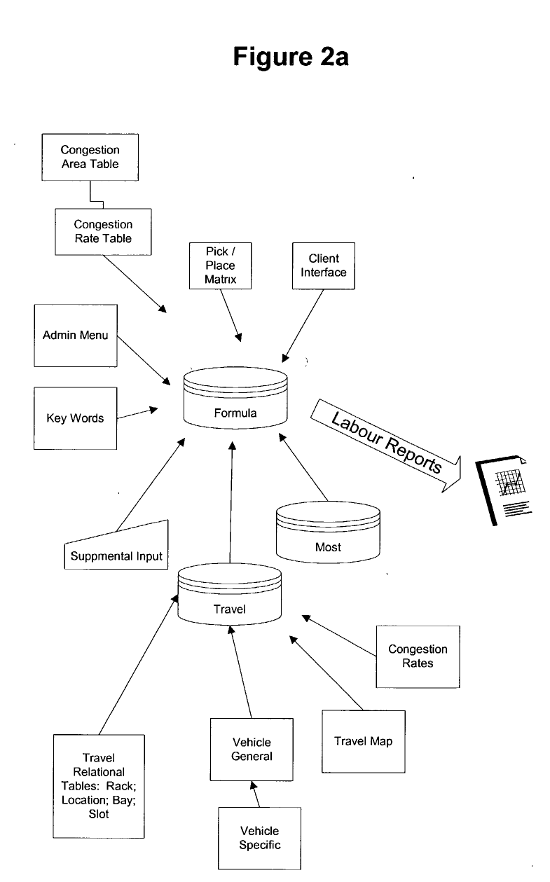

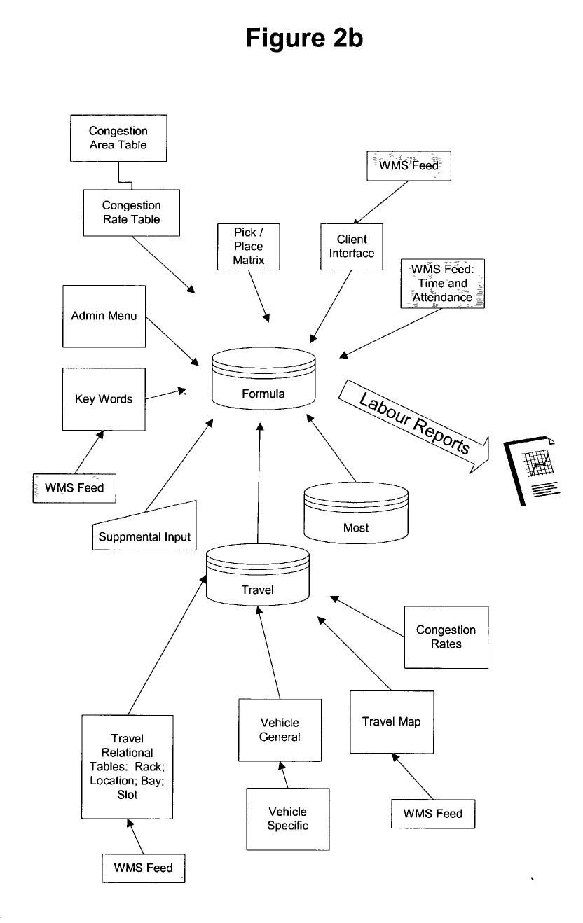

FIG. 2 illustrates an alternate embodiment of the present invention whereby the resources of the system of the present invention are integrated in a known WMS system 20.

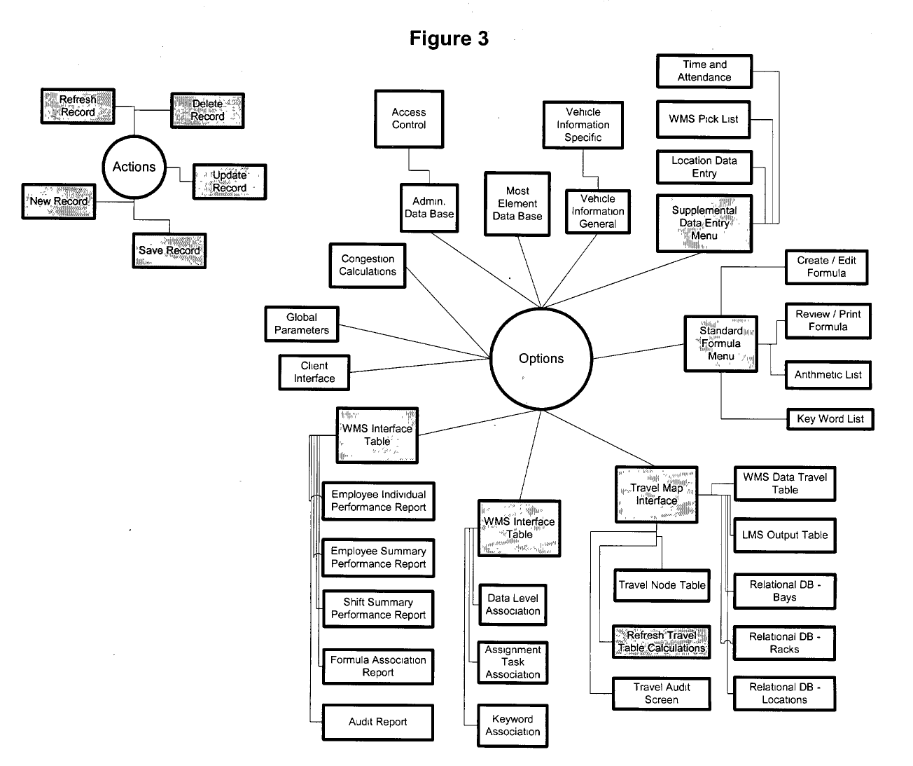

As illustrated in FIGS. 1a and 1b, loaded on the computer 10 is the computer program or labour standards application 22 of the present invention. The resources, inputs and functions of the computer program 22 are best understood by reference to FIGS. 2a, 2b, 2c and 3. The computer program 22 of the present invention includes a series of tools that facilitate the calculation of the time that a worker should take to perform a specific assignment; compare the time that a worker should take to perform a specific assignment with the time that it actually took the worker to perform the specific assignment; and report on the results of such comparison.

The two main components of the time required to complete an assignment are the time required to complete the task itself, and the time required to travel in order to complete the task. The present invention provides tools for readily establishing these components with relatively little programming expertise or skill in engineering labour standards.

In accordance with a first embodiment of the present invention, the computer program 22 obtains data from WMS system 20 via the data interface 16. One aspect of the computer program is a data facility 24 that translates such data to a format comprehensible by the computer program 22 of the present invention, if this is required. As is well known, the data supplied to the computer program 22 in accordance with this invention may be batched or provided in real time. Also, the data interface 16 may provide the data as exported text files from the WMS 20 or direct WAN table structures.

Generally speaking, the data utilized from a typical WMS system 20 falls into three categories: (1) information regarding specific locations in a physical space, including location names, location numbers, racking numbers and the coordinates of the foregoing; (2) time/attendance data regarding workers; and (3) pick lists or some other means of reflecting the distribution of particular tasks to a particular worker.

If the above data is not available from the WMS system 20 then the data is generally otherwise obtained from another system, or input manually.

The resources of the computer program 22 of the present invention are generally accessed through a WINDOWS™ type menu in a manner that is known. The menu is used to access the various data input interfaces discussed herein, as well as the functions of the various facilities described herein.

The deployment of the present invention includes a set-up phase whereby the input data required to support the processes described herein is provided to the computer program 22 of the present invention, as described below. This set-up phase may include verification of the formulae described below, supervision of entry of the data in support of the travel calculation facility 26, audit of procedures and so on. This set-up will usually be implemented by engineers and skilled programmers. Ongoing use of the present invention, however, is generally possible with dedicated non industrial engineer staff with some training. This is one of the advantages of the present invention.

One aspect of the present invention is a known administration facility 25 that permits the establishment and enforcement of hierarchical access to the various functions of the computer program 22 of the present invention. For example, in a representative hierarchical access structure established using the administration facility 25 only “ADMIN USERS” may be allowed to input data to the computer program 22 of the present invention, modify data, or access certain reports. “WORKER USERS” may only be given rights to access reports specific to them to monitor their performance in accordance with the engineered labour standards.

Travel Calculation Facility

As stated earlier, an important aspect of calculation of the time that it should take a worker to complete a specific assignment is travel time. For example, in the context of a typical warehouse, in relation to the picking and packing of a particular product, the time that it takes to travel to a particular aisle where the product is kept in the warehouse is an important component of the time it takes to complete this assignment.

One aspect of the present invention is a method for calculating the most efficient travel path between two points. Another aspect of the computer program 22 of the present invention is a travel calculation facility 26 that facilitates calculation of the most efficient travel path between two points in accordance with this method. One of the results of the operation of the travel calculation method and facility is the creation of a “travel map” layout of a particular physical space.

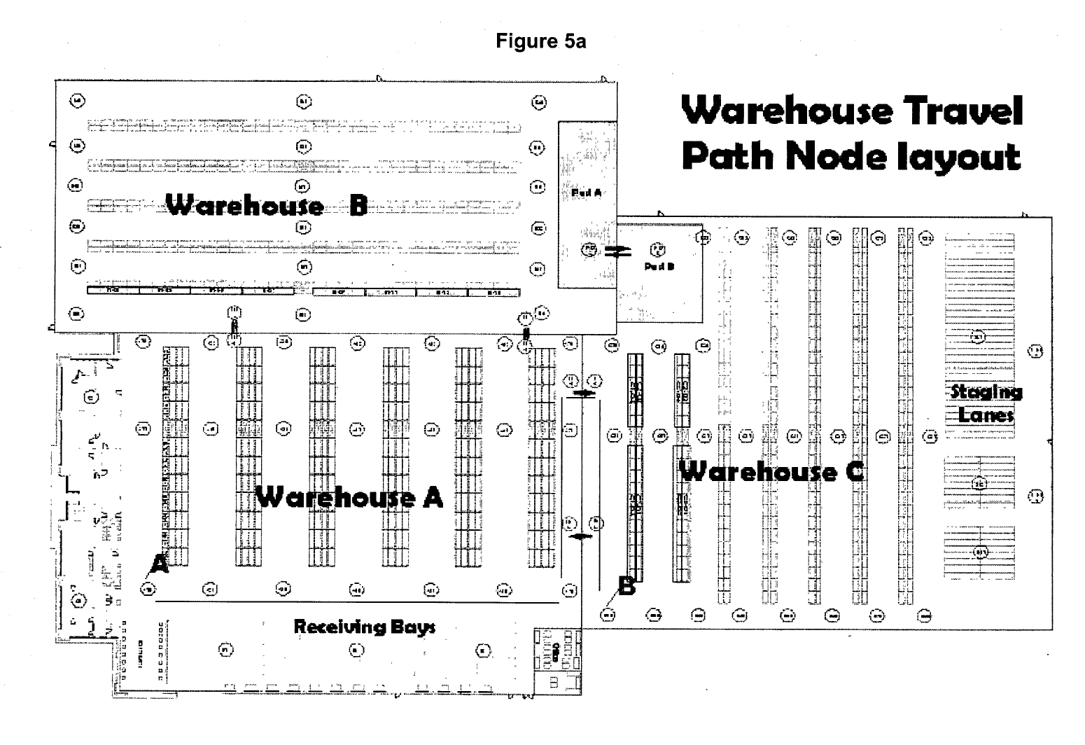

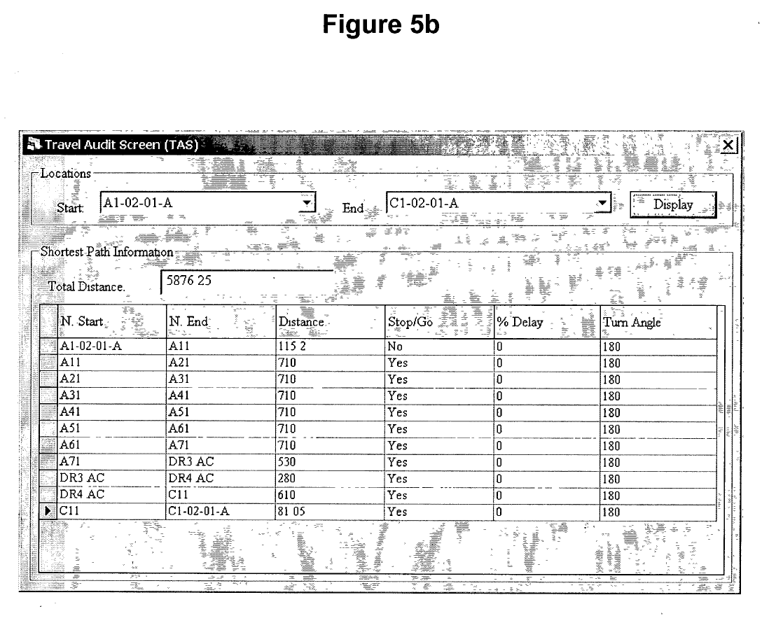

The physical space of interest, such as a warehouse is selected, as illustrated in FIG. 5a. A plurality of “travel nodes” or “travel points” 30 are selected within the physical space, unless this information is already obtained from the WMS system 20. The travel nodes 30 are specific points in the physical space selected because they are starting points, end points or mid-points in typical paths traveled by workers within the physical space. The travel nodes 30 are typically dispersed relatively evenly throughout typically traveled areas, as shown in FIG. 5a. In accordance with prior art methods and computer products, an aisle is generally assigned one equivalent of a travel node 30, whereas the time required to travel the most efficient path to the middle of an aisle, as opposed to either end of an aisle, may in fact differ. In this way, the travel nodes 30 of the present invention are based on real distance, as opposed to locations passed or aisles accessed.

The travel nodes 30 are typically selected by a user in the set-up phase described by reference to a warehouse plan such as the plan illustrated in FIG. 5a. One aspect of the computer program 22 of the present invention is that the travel calculation facility 26 and the database 14 cooperate to provide a relational database 36 in a manner that is known. This aids in the provision of the necessary input data to the permit the travel calculation facility 26 to calculate the most efficient travel path.

The travel calculation facility 26 includes one or more data input interfaces 32 provided in a manner that a worker other than a skilled programmer or engineer is generally capable of inputting the data required to operate the travel calculation facility 26.

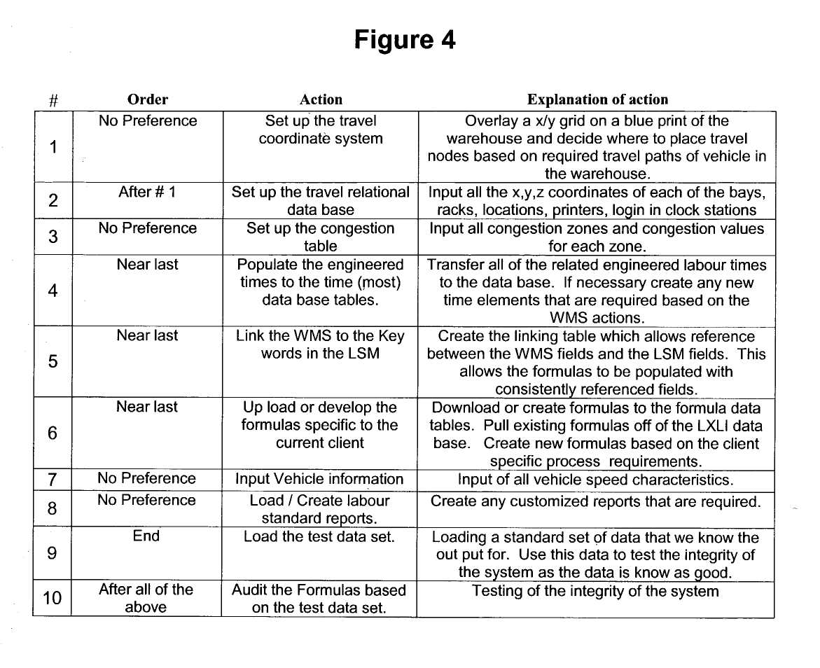

In one embodiment of the present invention, as described in FIG. 4, the following process is used to input the data required to operate the travel calculation facility 26:

1. An x/y grid is overlaid on a plan of a physical space.

2. The travel nodes 30 are placed as required in the x/y coordinates of the physical space.

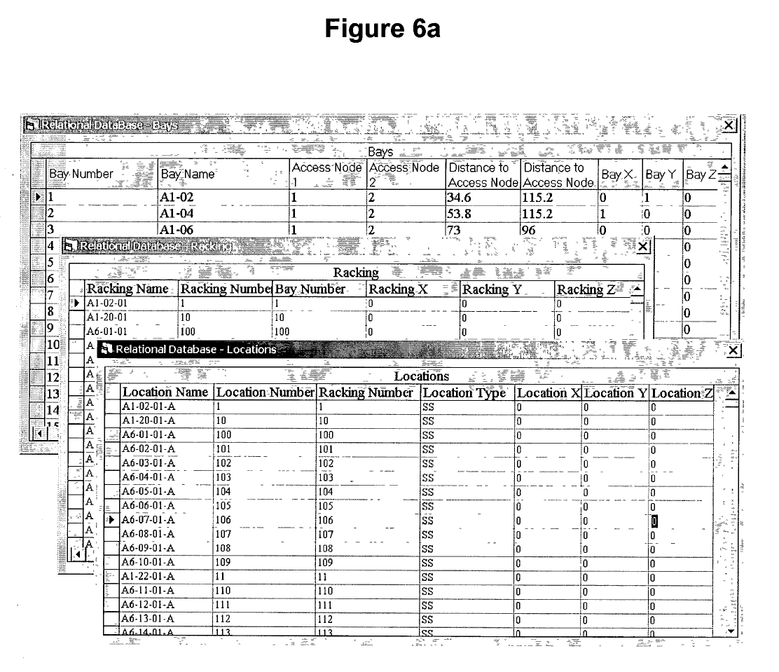

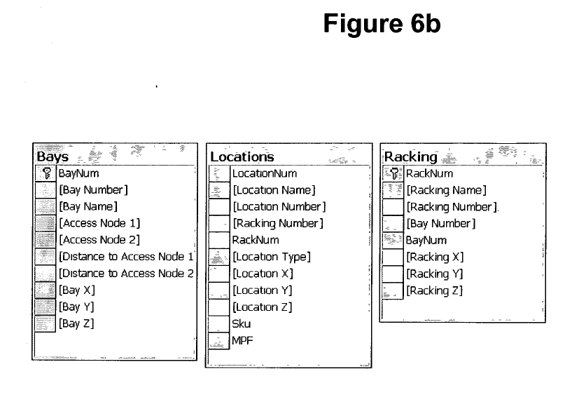

3. The x/y/z coordinates of each of the bays, racks, locations, printers, login stations and so on are inserted via the screens provided by the data input interface 32 illustrated in FIGS. 6a and 6b.

4. The above data is provided to the travel calculation facility 26.

5. The data is then preferrably audited using the screen shown in FIG. 5b.

FIG. 5a illustrates locations “A” and “B” and a line showing the shortest path therebetween. The travel calculation facility 26 permits such shortest path to be calculated between any two such points, as well as the time required to travel this shortest path.

In an aspect of the present invention, in step 1 of the above-referenced process, the following information is generally provided to the travel calculation facility 26 via the data input interface 32: (1) A travel node identifier such as a numeral; (2) An additional identifier such as a “NAME”, if required; and (3) the coordinates of each particular travel node. Corresponding information is provided in step 3 regarding the various bays, racks and other locations.

Typically, the data input interface 32 will also include spreadsheets for inputting data regarding the various sub-divisions of the physical space such as the rows, bays (sections of a row), racks and locations (sections of racks), as referenced above. This data includes the position of such sub-divisions of the physical space within the coordinates of the physical space. Some of the travel nodes 30 are “ACCESS NODES” in that they are passed in order to access sub-divisions of the physical space. For example, by reference to FIG. 5a, nodes are defined for accessing particular bays. The spreadsheets illustrated in FIG. 6a illustrate that the data input interface 32 receives data regarding a particular bay from each of its ACCESS NODES.

The travel calculation facility 26 links the data referenced above as illustrated in FIG. 6a.

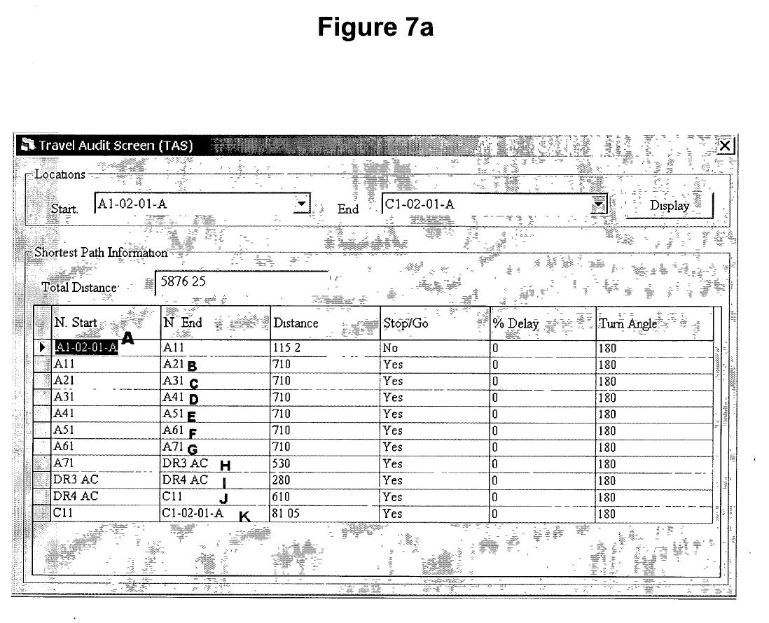

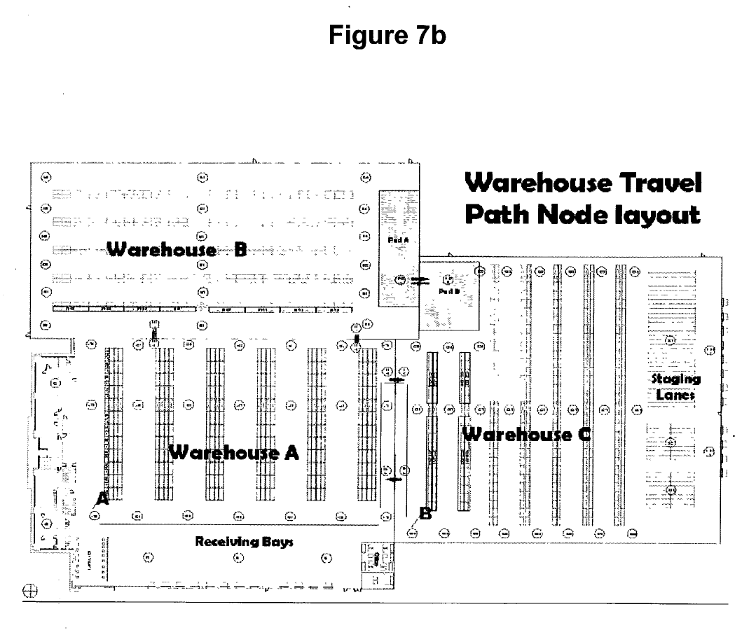

One aspect of the set-up phase of the present invention is the audit referenced in step 5 above. An aspect of this audit is the allocation during the set-up phase (in most cases by engineers) of adjustments to particular outputs of the travel calculation facility 26 to take account of factors not reflected in the algorithms employed by the travel calculation facility 26. In one aspect of the computer program 22, an audit facility 38 is provided. One aspect of the audit facility 38 is a “TRAVEL AUDIT SCREEN” illustrated in FIG. 7 in one embodiment thereof. Typically during the set-up phase described above, once the data relevant to the travel calculation facility 26 is inputted, the most efficient paths calculated by the travel calculation facility 26 are audited by reference to the plan of the physical space.

As illustrated in FIG. 5b, the “TRAVEL AUDIT SCREEN” provides a list of paths defined by the distance between any two travel nodes 30 along the same path in one direction. Generally speaking, engineers will analyze real life travel along such paths during business activities conducted in the physical space. The audit facility 38 is best understood as a tool that assists engineers in providing inputs to the travel calculation facility 26 based on such analysis in order for the gap between the data produced by the travel calculation facility 26 and the day-to-day circumstances occurring in the physical space to be as small as possible.

One such tool is a field in the “TRAVEL AUDIT SCREEN” whereby a value is assigned that represents an adjustment of the time required to travel between any two travel nodes 30 because travelling such path requires a vehicle to “STOP AND GO”.

“DISTANCE” is another aspect of the “TRAVEL AUDIT SCREEN” whereby distances between any two travel nodes 30 along the same path in one direction are inserted. Another aspect of the “TRAVEL AUDIT SCREEN” is that distance between any two given points can be increased to reflect for example that a particular path is one-way in the physical space.

The most efficient path and the time taken to travel along this path is also affected by the turn angles that can be achieved by a vehicle in particular circumstances. Another aspect of the audit facility 38 is that it permits the entry during the set-up phase of a permitted angle that a machine could safely turn without losing speed dependent on surface conditions, design restrictions of the machine, driver capabilities, aisle width and so on. This angle is used by the travel calculation facility 26 to calculation the most efficient path between any two travel nodes 30.

In another aspect of the present invention, the audit facility 38 permits the entry of a “TIME PENALTY” is generally used to reflect during the set-up phase circumstances not accounted for in the general travel formula utilized by the travel calculation facility 26 including for example surface conditions.

The result of the above, is that input parameters are provided to the travel calculation facility 26 that approximate the actual conditions of travel between defined travel nodes 30 in the physical space. Based on this information, as best shown in FIG. 7a, the travel calculation facility 26 calculates the most efficient path between two given travel nodes 30. To this end, the travel calculation facility 26 includes a travel formula or algorithm, provided in a manner that is known, that calculates the distance of each potential travel path in the travel node network. The travel formula then compares these distances to produce the shortest distance of such possible travel paths. These distances account for the input of the audit facility 38, as referenced above. FIG. 7a illustrates one particular distance between two particular travel nodes 30, namely A1-02-01-A and C1-02-01-A by calculating the distance between the various travel nodes 30 therebetween along a particular path in the travel node network.

In another aspect of the present invention, the present invention contemplates automation of aspects of the process described above. For example, the physical map of the location, including x/y coordinates would be created using a software program that permits data regarding travel nodes to be exported to the travel calculation facility 26 automatically by providing same to the database 14.

Task Calculation Facility

As stated earlier, another aspect of the calculation of the time it should take to complete an assignment, is the time it take to complete a task (i.e. without regard to travel time).

The time it takes to complete a specific task depends on a variety of factors. For example, the time it takes to pick a particular item off a particular location on a rack depends on the weight of the item and other product attributes, the speed at which the vehicle can lift items, the height of the particular item on the rack, congestion and so on.

In the field of engineered labour standards, calculating the optimal time to perform a specific task in view of the numerous parameters is time consuming and complicated. The complexity generally requires the use of engineers or other skilled and highly paid consultants, such that the cost of deploying of engineered labour standards can be prohibitive.

The task calculation facility 40 is a tool whereby the establishment of engineered labour standards directed at the calculation of time required to complete a task is made more efficient, and enables the use of workers or consultants with somewhat lesser skill. Each calculation requires a formula. The task calculation facility 40 is best understood as a “FORMULA BUILDER” which simplifies the process of selecting then applying the appropriate formulae based on the building blocks of each particular task.

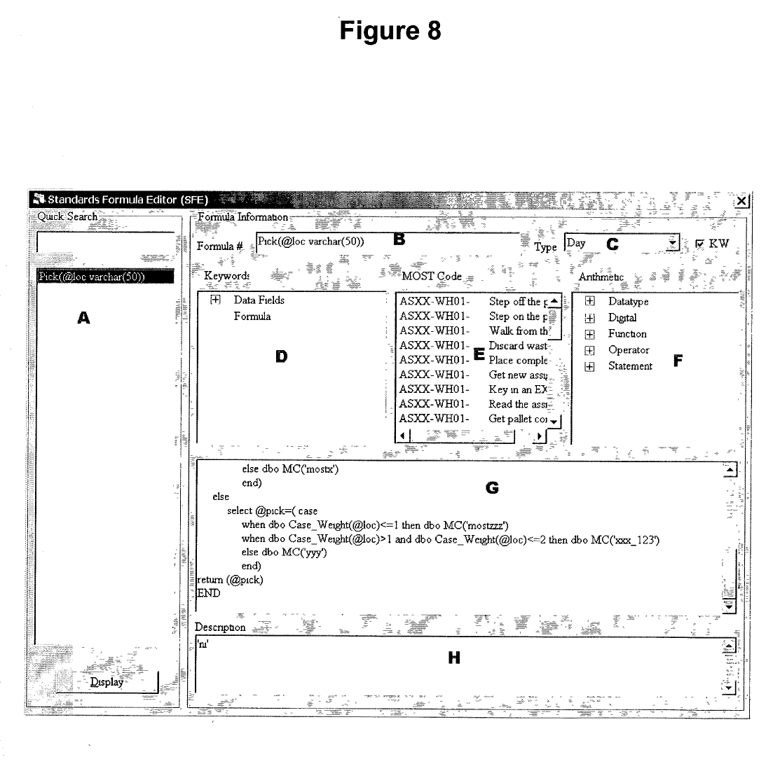

The operation of the task calculation facility 40 is best illustrated by reference to FIG. 8. Each individual formula is given an identifier that is generally a descriptive name such as “PICK and PACK PICK—Type AA”. Each task generally includes a number of elements whereby each element takes a certain amount of time. The user of task calculation facility 40 builds the formula using an element repository 42 provided in co-operation with the database 14. The element repository 42 is a series of preprogrammed discreet task components with the associated formulae for calculating the time required to complete same in a typical implementation of the present invention. It should be understood that particular implementations of the present invention may require during the set-up phase the engineering of new elements to be included in the element repository 42. Nonetheless, after the provision of such additional elements, a user can build formulas by selecting elements and the arithmetic operators that identify the relationship between consecutive elements.

The following example illustrates the task calculation facility 40 in operation.

As shown in FIG. 8, the task calculation facility includes a data interface screen that is a “FORMULA BUILDER” or “STANDARDS FORMULA EDITOR”. This function is accessed by a known WINDOWS™ menu associated with the computer program 22. The “FORMULA BUILDER” includes a number of options that can be selected by a user including “CREATE/EDIT FORMULA”. In a particular embodiment of the present invention, the selection of the “CREATE/EDIT FORMULA” option opens the particular screen shown in FIG. 8.

The user of the “FORMULA BUILDER” can at this point can select a formula from a list of formulas accessible through a drop-down menu (A), and edit the formula. Alternatively, the user can select “NEW RECORD” not shown and select from a series of formula templates from the database 14. The present invention also contemplates the use of a known help utility 44 or formula builder wizard for aiding the user in the operation of the “FORMULA BUILDER”. Such utility is provided in a manner that is known.

The name of the new formula is entered by the user in (B).

The hierarchy level of the particular new formula is selected at (C). The hierarchy levels are designed to facilitate the operation of the task calculation facility 40 in a manner that reduces duplication, reducing error and promotes consistency throughout the various formula elements thereby assisting in the efficient use thereof.

The formula hierarchy determines at what levels you can create formulas. Each formula is composed of several keywords and standard elements. Each of the components of the formula is linked to different levels (explained below). Below are the rules that all formulas must follow.

All elements are available to every level of formula.

All Keywords are linked to one or several formula levels.

Each key word can be utilized within the associated formula level only.

Formulas can not be created across hierarchy levels.

Formulas of different levels can be added together but the components of each formula can't be calculated together.

Level 1: Day Level—examples: prep tm for the day, log in and out time

Level 2: Job Class Level—examples: prep time for each job class

Level 3: Assignment Level—examples: all tasks, move loc A to b, get on and off pallet

Level 4: Location Level—example: picking with in a location

The formulas are built by selecting functions organized into three categories. The first is function category (D). Examples of function categories include Digital, Function, and Operator. These functions are groupings of mathematical numbers, predetermined formulas or mathematical expressions. Some examples are:

Digital: 1,2,3,4,5,6,7,8,9,0 (The numbers them self)

Formulas: Average, Max, Sum, Power, Substing

Operators: +, −, *, \hat{ },

These categories help the user drill down to the formula elements that apply to a particular task according to task descriptions.

The second category includes the engineered time formulas for discrete elements of tasks. These are already provided to the element repository 42 as part of the set-up phase by engineers. The engineered time formulas are based on known methods of calculating the time to complete specific elements of tasks based on the relevant parameters. These are engineered based on measurements taken of the workflow using templates or engineered by exercise of the skill of an ordinary industrial engineer.

The third category is the “Arithmetic” or relationship between constituent elements of a task expressed in the formulas for specific elements of a task.

FIG. 8 illustrates the creation of a formula for calculating the picking of a case. Depending on the physical location, and the location of the case in a warehouse, for example, this task may include the following constituent elements weight and volume of the case. Specifically, weight in groupings of less or equal to 1 kg, 1-2 kg or other. For volume groupings of cube at less or equal to 1 cb ft, 1-2 cb ft or other. Each of these tasks is represented by a series of formulae that can be selected from the element repository 42 at (E).

The task calculation facility 40 is adapted to request data inputs from the user to complete specific calculations in accordance with formulas created using the “FORMULA BUILDER”. For example, in the case of picking a case, the weight and the volume of a particular case will affect the time calculation for completing this task. Therefore, these values are requested by the task calculation facility 40. In operation of the computer program 22, these values are generally obtained from extraneous sources (for example from the WMS20).

The format of the formulas discussed is provided in a manner that is known, for example, using a format similar to SQL.

Once a new formula is created, the user can “SAVE RECORD” and the formula is now stored to the database 14.

This enables formulas to be built for specific tasks easily and efficiently. This also provides flexibility in that new formulae for new tasks can also be built easily and efficiently. The method described above also promotes transparency in that the method by which a particular engineered labour standard is calculated and established can be readily demonstrated.

An important aspect of the present invention, is that the task calculation facility 40 and the database 14 also cooperate to provide a relational database 36 whereby changes made to any of the factors affecting a particular formula dynamically update the result of the processing of any such particular formula. This decreases the time required to update the engineered labour standards established and enforced in accordance with the present invention.

In accordance with the present invention, the travel calculation facility 26 and the task calculation facility 40 cooperate to calculate optimal time to complete a particular assignment. The main attributes of a particular assignment is the DAY; the JOB or WORKER (in the sense of their identity); the nature of the assignment; and the location of the assignment (starting point, and end point).

This optimal time is affected by two other significant factors that are addressed by the present invention. The first is the efficacy of the particular vehicle used by a particular worker. The second is congestion.

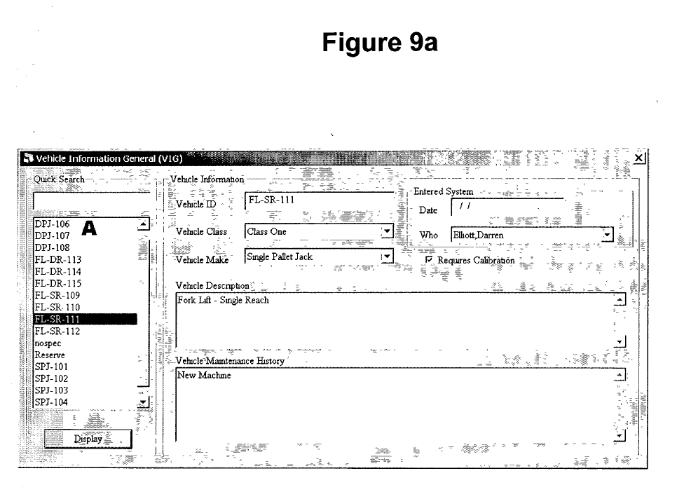

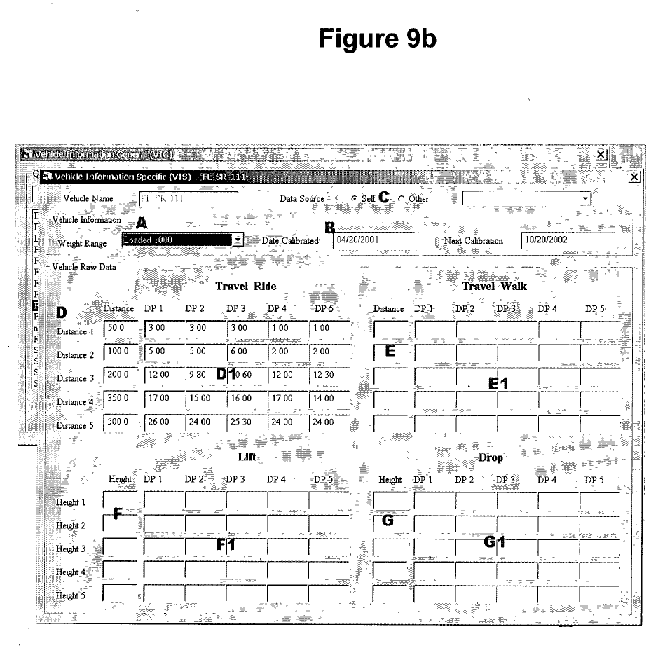

The performance of each individual vehicle is measured having regard to velocity and acceleration. In a particular embodiment of the present invention, this information is provided to a table such as the table illustrated in FIG. 9a. The example provided relates to a forklift where the relevant velocity information extends to lifting and dropping speeds. The present invention also contemplates reflecting other performance data such as turn ratios and the like.

As illustrated in FIG. 9a, the user opens the “VEHICLE INFORMATION GENERAL” screen through the WINDOWS menu. A particular vehicle is selected. The screen shown in FIG. 9b will appear. This screen permits the entry of information regarding vehicle attributes or the use of information for another vehicle with modifications as are required.

Where specific vehicle data is input, the following method is generally used. It is selected whether the data is input “SELF” or obtained first from a file in database 14 for another vehicle “OTHER” (C). A weight range is entered (A). The date the vehicle was calibrated and when it next should be calibrated is entered (B).

Alternatively, data is accessed from another vehicle “OTHER” and modified a required.

In the specific example of a forklift, the input parameters include “TRAVEL RIDE”, “TRAVEL WALK”, “LIFT” and “DROP” test results.

In relation to “TRAVEL RIDE” and “TRAVEL WALK”, the values of specific distances and measured times in seconds required to reach such distance are entered. TRAVEL WALK is when you walk beside the pallet jack but reach over and steer it as you walk. This is typically used for distances under 15 feet. TRAVEL RIDE is when you get on the pallet jack and ride from location a to location b. This is typically used for longer distances.

Similarly data regarding the time taken to lift and drop goods is also measured.

The above data is collected at various different times: DP1, DP2, DP3, DP4, DP5.

The vehicle being used by a particular worker on a particular day is generally associated with the JOB attribute of the assignment, such that the time allotted to a specific assignment is increased, for example, if a worker is using a vehicle that is slower.

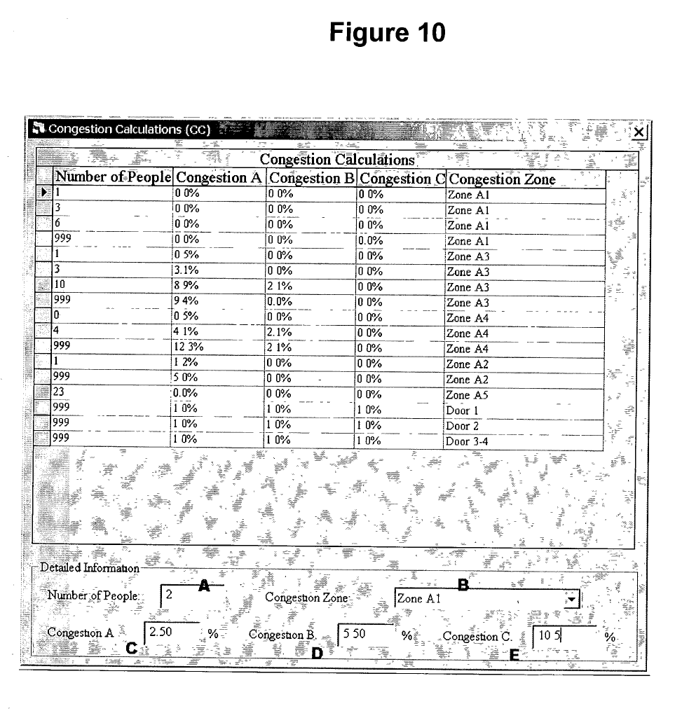

Congestion is addressed by looking at zones in the physical space to establish one or more congestion zones, as best illustrated in FIG. 10. As part of the set-up phase, by taking samples, it is determined within each zone what percentage of the time there is congestion depending on the number of the people working, as shown in FIG. 10. This establishes a sliding scale of congestion in defined areas dependent on the number of workers in the physical space at any given time.

The computer program 22 of the present invention accounts for congestion by combining the results of the task calculation facility 40 and travel calculation facility 26 such that extra time is given for a particular task that involves intersecting with one or more congestion zones based on the sample data referred to above.

Reporting Facility

In accordance with the present invention, a pick list or some other means of distributing assignments to specific workers establishes a list of particular assignments distributed to a particular individual on a particular day. This particular individual may be using a vehicle with particular performance attributes. The particular day may have particular congestion attributes, depending on the number of other workers on duty that day.

The pick list or other tool will generally record the total number of assignments completed by the worker on the particular day.

The computer program 22 of the present invention receives the above mentioned data. The method and computer program 22 of the present invention permits then permit the calculation of the optimal time for completing each of the above assignments, whereby the optimal time includes time for completing task and also the associated travel time along the most efficient path, as explained above. Thereby, the method and computer program 22 of the present invention permits the calculation of the time that it should have taken the worker to complete all of the assignments distributed to that worker.

The present invention also includes a reporting facility 46 that enables the generation of reports based on this data. For example, each particular assignment completed by a worker can be expressed in a report as a percentage of the expected average in relation to the optimal time referred to above. Similar reports with this comparative percentage can be generated for a particular worker over a defined time period whether a day, week, month or year, for example. Or related information can be generated in a report for a particular shift. A particular embodiment of the reporting facility uses a known tools such as CRYSTAL REPORTS™.

It should be understood that implementation of engineered labour standards can result in a thirty percent increase in labour efficiency in some cases. This can result in an improvement of output. Or, labour being a significant cost of business this can result in cost savings. The legitimacy of particular engineered labour standards and/or the implementation of same may be challenged, for example by unions. The transparency and reliability of engineered labour standards implemented in accordance with the present invention facilitates worker and labour buy-in.

The present invention also contemplates providing a simulation routine in an aspect of the computer program of the present invention. In this aspect of the invention, the results of operation of the computer program based on actual data (for example data feed from a WMS) would be compared with the results of operation of the computer program in accordance with simulation data in a simulation routine. This permits the analysis of the comparison of changes on the output by alteration of input (e.g. changes in physical environment, travel node network, new formulas etc.).

We claim:

1. A method for establishing labour standards for a workplace comprising the following steps:
(a) mapping the workplace by establishing a travel node network including a plurality of travel nodes in xyz coordinates, each travel node corresponding to a location in the workplace;
(b) calculating the most efficient travel path between each of any two such travel nodes using a labour standard application; and
(c) establishing labour standards at the workplace based on said most efficient travel paths.

2. The method claimed in claim 1 whereby during a set-up phase the parameters affecting the calculation of the most efficient travel paths are engineered and programmed to the labour standard application.

3. The method claimed in claim 2 further comprising the step of auditing the engineered parameters using an audit facility.

4. A method for establishing labour standards comprising the following steps:
(a) providing a task calculation facility that includes a formula builder for building formulae for calculating the time required to complete one or more tasks at the workplace;
(b) selecting one or more of a plurality of formula elements from an element repository using the formula builder;
(c) combining the formula elements using the formula builder to define a series of task calculation formulae;
(d) applying the task calculation formulae to data inputs to calculate the time required to complete a task; and
(e) establishing labour standards at the workplace based on the calculated time required to complete tasks at the workplace.

5. A method for establishing labour standards at a workplace comprising the steps of:
(a) calculating the time required to complete a task at the workplace independent of travel time using a task calculation facility;
(b) calculating the time required to complete travel involved in the completion of the task based on the calculation of the travel time between a first location and a second location using a travel calculation facility, said travel being required in order to complete the task;
(c) combining the results of (a) and (b) to define the total time required to complete the task; and
(d) establishing labour standards at the workplace based on such total task completion time.

6. A system for establishing labour standards at a workplace comprising:
(a) a computer;
(b) a database functionally linked to the computer;
(c) A computer program loaded on the computer whereby the computer and computer program are functionally linked to provide:
i) A travel calculation facility that facilitates the creation of a travel map of the workplace that is stored to the database, said travel map being based on a network of travel nodes;
whereby the travel calculation permits the calculation of the most efficient travel path between a first location and a second location; and
Whereby the travel calculation facility facilitates the establishment of labour standards at the workplace.

7. A system as claimed in claim 6, wherein the system further includes a travel audit facility that facilitates the auditing of the calculations of the travel calculation facility.

8. A system as claimed in claim 6, wherein the system further includes an administration facility for managing access to the resources of the system.

9. A system as claimed in claim 6, wherein the system further includes a reporting facility for reporting the output data of the system in reports having a selected format.

10. A system as claimed in claim 6, wherein the travel calculation facility calculates the time required to travel between the first location and the second location along a plurality of possible paths, compares the time required to travel the plurality of possible paths, and provides as an output the path between the first location and second location that requires the least amount of time.

11. A system as claimed in claim 10, wherein the travel audit facility enables the output of the travel calculation facility to reflect:
(a) “STOP” and “GO” requirements during travel between the first location and the second location;
(b) One-way travel paths between the first location and the second location; and
(c) The turn angles that a vehicle can safely travel between the first location and the second location.

12. A system as claimed in claim 11, wherein the travel audit facility further enables the output of the travel calculation facility to reflect a “TIME PENALTY” to account for additional factors in calculating the required time to travel between the first location and the second location.

13. A system as claimed in claim 10, wherein the system further includes a task calculation facility, said task calculation facility including:
(a) A formula builder that is functionally linked with the database to provide a formula element repository whereby the formula builder facilitates the creation of formulae for the calculation of the time required to complete a task;
whereby the task calculation facility receives input data determined by the formulae and runs the formulae to produce as output data the time required to complete a particular task.

14. A system as claimed in claim 13, wherein the formula builder enables the selection of one or more formula elements represented by a plurality of corresponding keywords to construct a formula for the calculation of the time required to complete a task.

15. A system as claimed in claim 14, wherein the formula elements include formula functions, engineered time formulae for task elements, and arithmetic functions.

16. A system as claimed in claim 15, wherein the task calculation facility further includes a vehicle information facility that permits the input of data related to the performance of one or more vehicles whereby the output data of the task calculation facility reflects the vehicle performance data.

17. A system as claimed in claim 16, wherein the system further includes a congestion facility which:
(a) Facilitates the collection of data regarding the travel congestion factors applicable in the workplace at defined times to produce congestion data; and
(b) Applies the congestion to the output data of the task calculation facility.

18. A computer program for establishing labour standards at a workplace, the computer program comprising:
(a) A travel calculation facility that facilitates the creation of a travel map of the workplace that is stored to the database, said travel map being based on a network of travel nodes and permits the calculation of the most efficient travel path between a first location and a second location; and
(b) a task calculation facility, said task calculation facility including:
i) A formula builder that is functionally linked with the database to provide a formula element repository whereby the formula builder facilitates the creation of formulae for the calculation of the time required to complete a task;
whereby the task calculation facility receives input data determined by the formulae and runs the formulae to produce as output data the time required to complete a particular task; and whereby the computer program combines the task calculation and travel calculation output data to define the time required to complete a task thereby enabling the establishment of labour standards based on such combined data.

19. A computer program as claimed in claim 18, further including an auditing facility for facilitating the auditing of the processes of the travel calculation facility to account for workplace specific conditions such as one-way travel paths, turn angles safely turned by a vehicle and “STOP” and “GO” requirements between the first location and the second location.

20. The computer program claimed in claim 19, further including a reporting facility for generating a plurality of reports in selected format based on the output data of the travel calculation facility, the output data of the task calculation facility, or the output data of each of the travel calculation facility and the task calculation facility in combination.
